(19) United States
(12) Patent Application Publication
(10) Pub. No.: US 2002/0163813 A1
(43) Pub. Date: Nov. 7, 2002

(54) Suspending and assembling structure for ceiling lamp

(76) Inventor: Ming-Chi Tseng, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/919,816

(22) Filed: Aug. 2, 2001

Related U.S. Application Data
(63) Continuation-in-part of application No. 09/847,421, filed on May 3, 2001.

(51) Int. Cl. F21S 8/06

(52) U.S. Cl. 362/404; 362/226; 362/406

(57) ABSTRACT

A suspending and assembling structure for ceiling lamp, including a connecting having an upward extending tube. An inner wall of the tube is formed with two radially opposite slide channels and two radially opposite engaging notches. The lamp seat of the ceiling lamp has an upward extending hollow post. A pin member is radially passed through the post near the top end thereof. Two ends of the pin member protrude out of the post. The post is upward fitted into the tube and rotated to aim the pin member at the engaging notches and engage and locate the pin member in the engaging notches.

### CROSS-REFERENCE TO RELATED APPLICATION

This application is a Continuation-In-Part application of Ser. No. 09/847,421, filed May 3, 2001, and entitled “FAST ASSEMBLING STRUCTURE FOR CEILING FAN LAMP AND CEILING FAN.”

### BACKGROUND OF THE INVENTION

The present invention is related to a suspending and assembling structure for ceiling lamp, and more particularly to a fast assembling structure by which by way of insertion, the ceiling lamp is suspended and at the same time the wires are electrically connected.

FIGS. 12 and 13 show a conventional suspending and assembling structure for ceiling lamp. The ceiling lamp is installed below a ceiling fan 8. A hollow thread rod 82 is disposed in the lamp seat 81 of the ceiling lamp and screwed into a thread hole 831 of the base tray 83 of the ceiling fan 8. The base tray 83 is locked on the bottom of the ceiling fan 8. Two leads 811 of the lamp seat 81 are passed through the thread rod 82 to connect with the leads 84 extending out from the ceiling fan 8.

Prior to installation of the lamp seat 81, a cock 87 is plugged in the thread hole 831 to keep the base tray 83 flush. When installing the lamp seat 81, the base tray 83 is first detached from the bottom of the ceiling fan 8 and then the cock 87 is removed to screw the thread rod 82 into the thread hole of the base tray 83. Accordingly, the base tray 83 is locked on the lamp seat 81. Then, the leads 811 of the lamp seat 81 and the leads 84 of the ceiling fan 8 are connected by wire-connecting caps 85. Then the base tray 83 is fitted with and locked on the bottom of the ceiling fan 8 by several locking bolts 86.

Such installation procedure is quite troublesome to a DIY user. Especially, the ceiling fan 8 is often first mounted on the ceiling and then the lamp seat 81 is installed. Therefore, when using the wire-connecting caps 85 to connect the leads 811 of the lamp seat 81 with the leads 84 of the ceiling fan 8, it is necessary for another person to help and hold the lamp seat 81. Otherwise, the user will have to on one hand hold the lamp seat 81 and on the other hand connect the leads. This is quite inconvenient for the user. When locking the base tray 83, it is also necessary to on one hand hold the lamp seat 81 and on the other hand lock the base tray 83.

### SUMMARY OF THE INVENTION

It is therefore a primary object of the present invention to provide a suspending structure for ceiling lamp, which includes a base tray and a lamp seat. The base tray for connecting with the ceiling lamp has an upward extending tube in which a post of the lamp seat is fitted. An inner wall of the tube is formed with two radially opposite slide channels and two radially opposite engaging notches. A pin member is radially passed through the post. Two ends of the pin member protrude out of the post. When the post is upward fitted into the tube, the pin member passes through the two slide channels. Thereafter, the post is rotated to aim the pin member at the engaging notches to make the pin member engaged and located in the engaging notches.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a sectional view taken along line III-III of FIG. 1;

FIG. 4A is a sectional view showing the assembling operation of the present invention in a first state;

FIG. 4B is a sectional view showing the assembling operation of the present invention in a second state;

FIG. 4C is a sectional view showing the assembling operation of the present invention in a third state;

FIG. 5 shows another embodiment of the present invention in which a coil spring is further provided;

FIG. 6 is a perspective exploded view of still another embodiment of the present invention;

FIG. 7A is a sectional view of the other embodiment of the present invention;

FIG. 7B is an enlarged view of a part of FIG. 7A;

FIG. 8A shows the ratchet sections of the tube and the base tray;

FIG. 9A is a top view showing that the hollow post is connected with the tube of the present invention in one state;

FIG. 9B is a top view showing that the hollow post is connected with the tube of the present invention in another state;

FIG. 10A shows the assembly of the present invention in one state;

FIG. 10B shows the assembly of the present invention in another state;

FIG. 10C shows the assembly of the present invention in still another state;

FIG. 11 shows still another embodiment of the present invention;

FIG. 12 is a perspective exploded view of a conventional ceiling lamp suspending below a ceiling fan; and

FIG. 13 is a sectional assembled view according to FIG. 12.

### DETAILED DESCRIPTION OF THE PREFERRED EMBODIMENTS

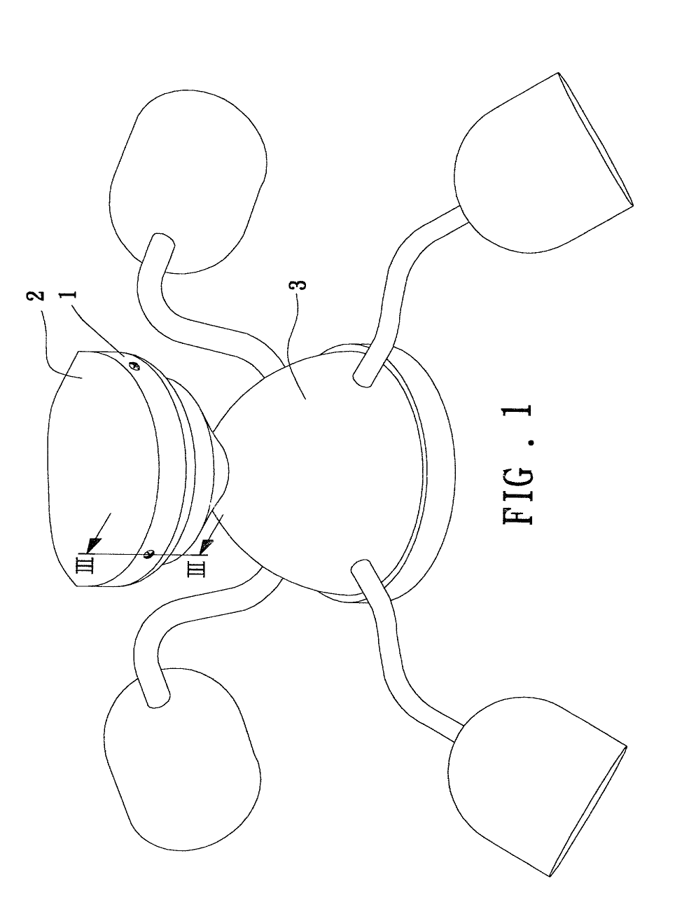

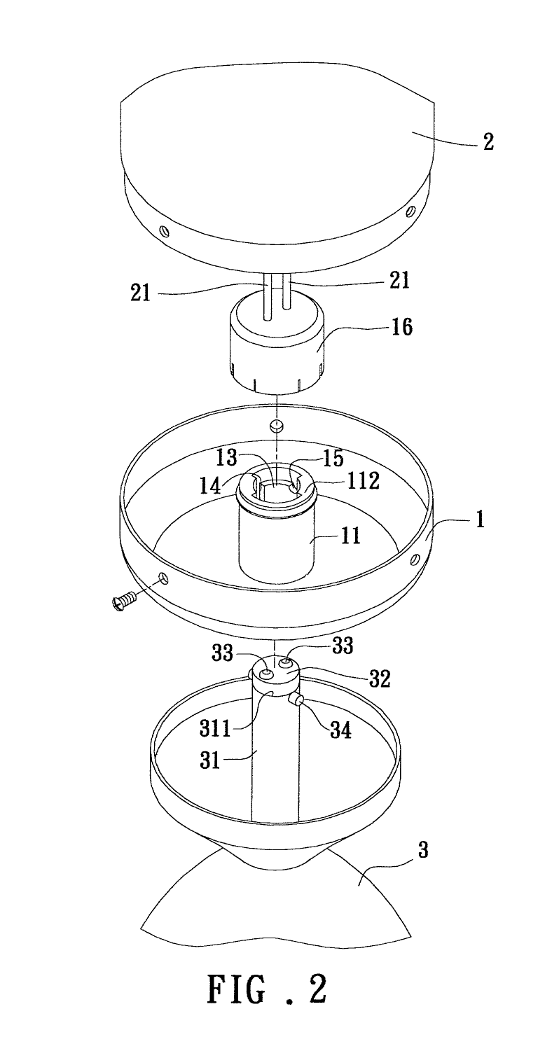

Please refer to FIGS. 1 to 4 which show a preferred embodiment of the suspending and assembling structure for ceiling lamp of the present invention. In this embodiment, the ceiling lamp is suspended below the ceiling fan 2. The structure includes a base tray 1 and a lamp seat 3.

The base tray 1 is connected with the bottom of the ceiling fan 2 and has an upward extending tube 11. The tube 11 has a bottom end 111 connected with the base tray 1 and a top end 112 opposite to the bottom end 11. An inner wall 13 of the tube 11 is formed with two radially opposite slide channels 14 axially passing through the tube 11. In addition, the inner wall 13 is formed with two radially opposite engaging notches 15. The top end of the tube 11 is provided with a cap 16 in which a wire-connecting disc 17 is disposed. A spring 18 is disposed between the wire-connecting disc 17 and the cap 16. In normal state, the spring 18 pushes the wire-connecting disc 17 downward. The wire-connecting disc 17 is connected with a circuit 21 arranged in an internal switch box of the ceiling fan 2 and has two downward extending first contacts 19.

The lamp seat 3 has an upward extending hollow post 31 for fitting into the tube 11. The post 31 has a top end 311 fitted into the tube 11 and connected with a wire-connecting seat 32. The wire-connecting seat 32 is connected with the wires inside the lamp seat 3 and has two second contacts 33 corresponding to the first contacts 19 of the wire-connecting disc 17. A pin member 34 is radially passed through the post 31 near the top end 311 thereof. Two ends of the pin member 34 protrude out of the post 31 and are slidably accommodated in the slide channels 14 of the tube 11, whereby the post 31 can be upward fitted into the tube 11. After the post 31 is rotated to aim the pin member 34 at the engaging notches 15, the spring 18 resiliently pushes the pin member 34 to engage and locate in the engaging notches 15. At this time, the second contacts 33 of the wire-connecting seat 32 electrically contact with the first contacts 19 of the wire-connecting disc 17.

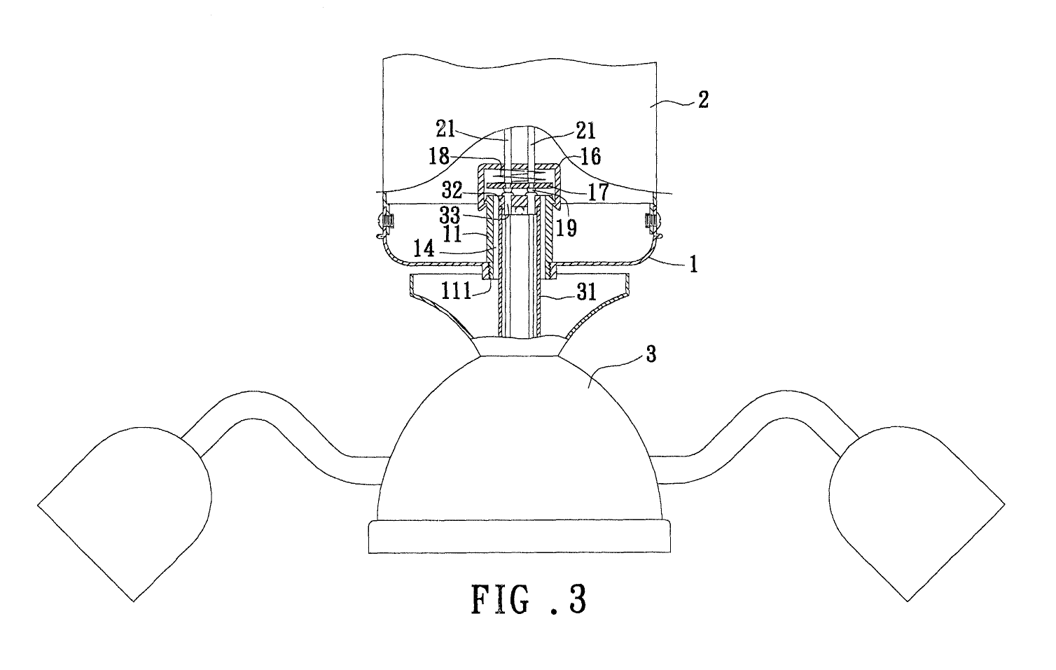

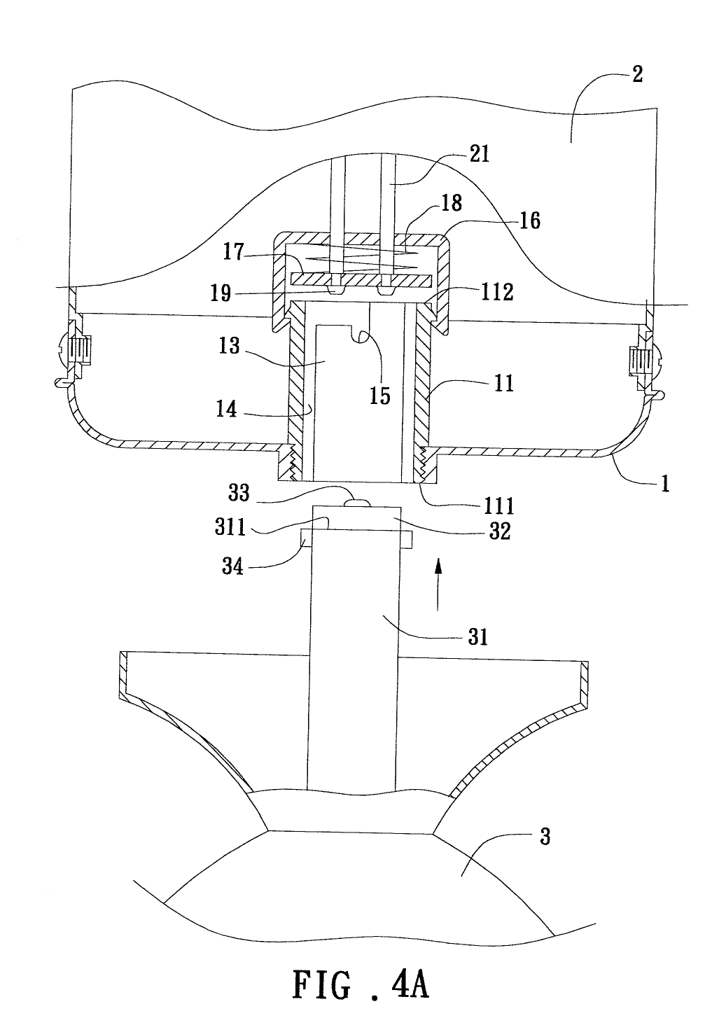

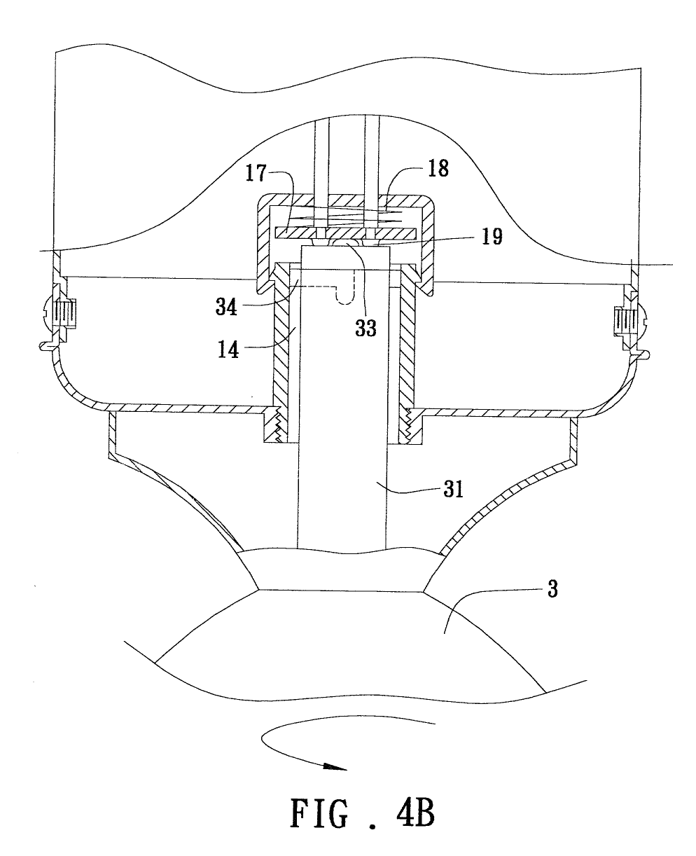

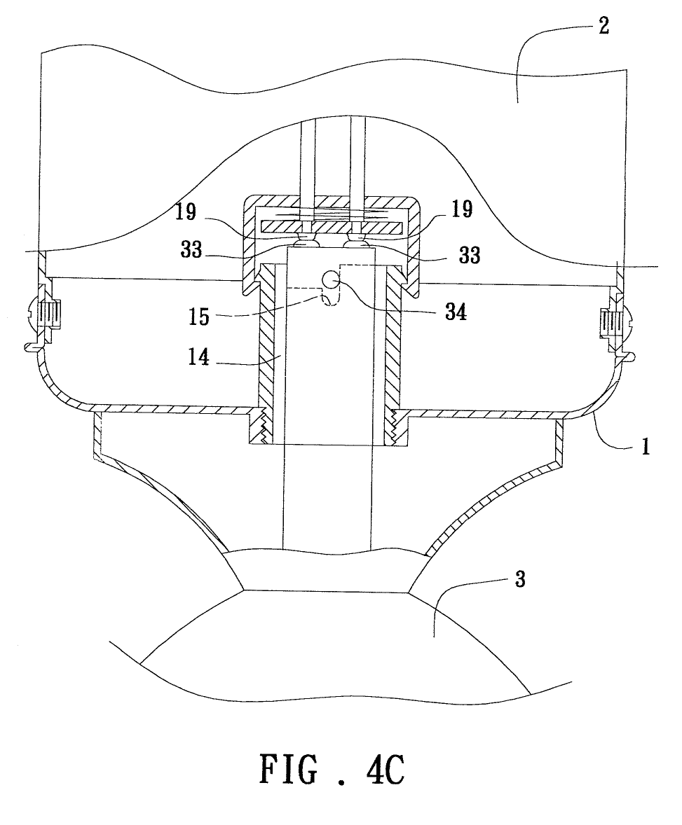

In manufacturing, the wire-connecting seat 32 is disposed at the top end of the post 31 with the second contacts 33 protruding beyond the top face of the wire-connecting seat 32. The base tray 1 is locked on the bottom of the ceiling fan 2 with the tube 11 fitted with the cap 16. A cock (not shown) is plugged in the bottom end 111 of the tube 11 to seal the tube 11. When the lamp seat 3 is not installed, the bottom end 111 of the tube 11 is kept flush. Referring to FIG. 4A, when a user DIY assembles the lamp seat 3, the user only needs to unplug the cock and respectively aim the post 31 and pin member 34 of the lamp seat 3 at the tube 11 and the two slide channels 14 to upward fit the post 31 into the tube 11. After the pin member 34 passes through the slide channels 14 as shown in FIG. 4B, the post 31 is rotated to aim the pin member 34 at the engaging notches 15 as shown in FIG. 4C. At this time, the second contacts 33 of the wire-connecting seat 32 electrically contact with the first contacts 19 of the wire-connecting disc 17 to close the circuit. The spring 18 resiliently pushes the wire-connecting disc 17 to press the post 31 downward so as to engage the pin member 34 into the engaging notches 15. Under such circumstance, the post 31 is connected with and located in the tube 11 as shown in FIG. 3. Accordingly, simply by means of inserting the post 31 into the tube 11 and then rotating the post 31, the ceiling fan 2 and the lamp seat 3 can be quickly connected and the ceiling lamp is suspended below the ceiling fan 2. At the same time, the wires are electrically connected.

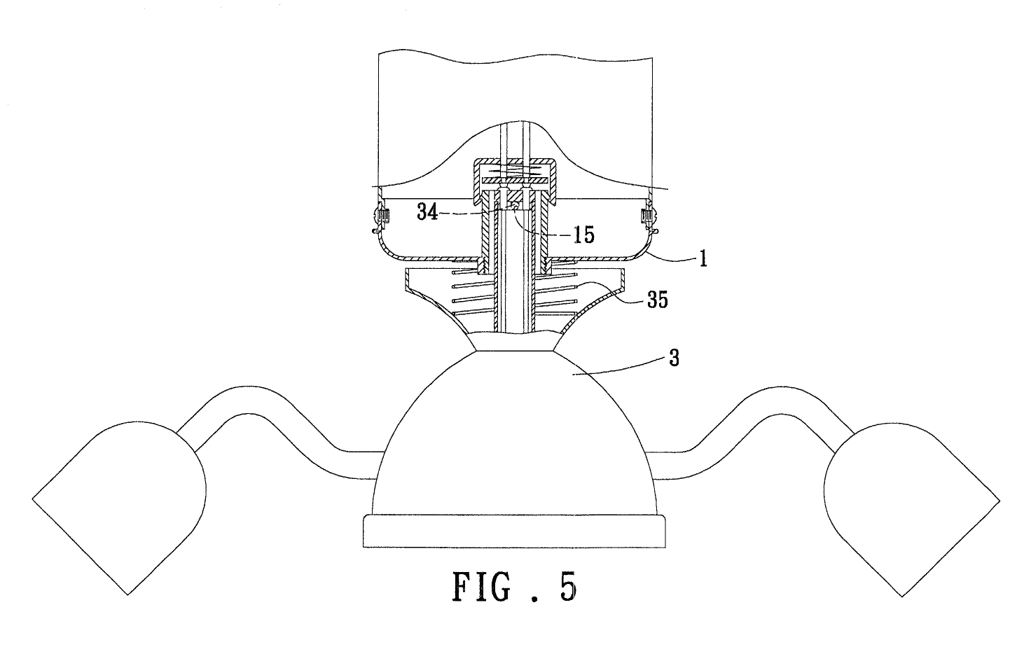

FIG. 5 shows another embodiment of the present invention, in which a coil spring 35 is additionally disposed between the lamp seat 3 and the base tray 1 for pushing the lamp seat 3 downward to more firmly engage the pin member 34 in the engaging notches 15. This embodiment can achieve the same effect as the first embodiment.

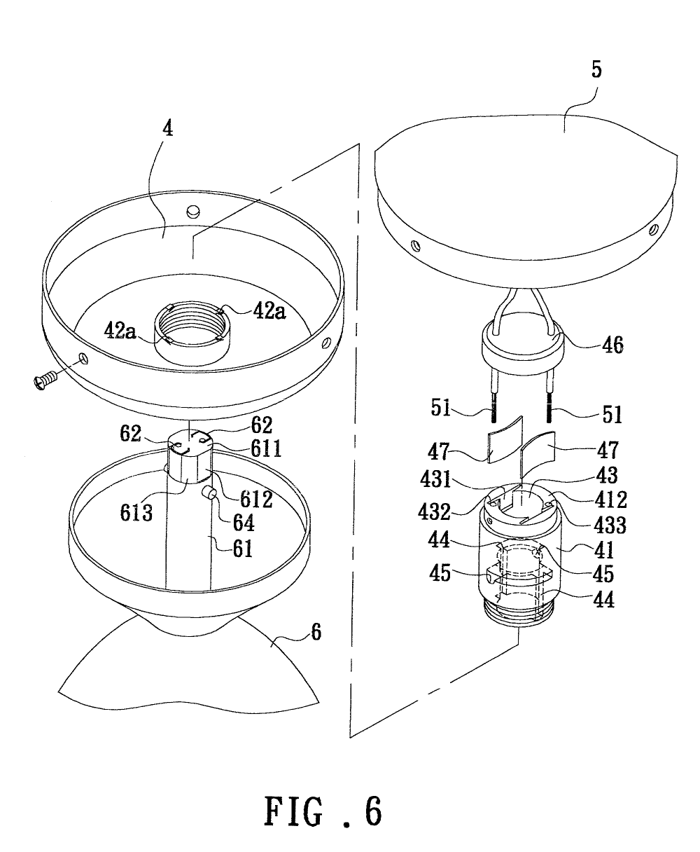

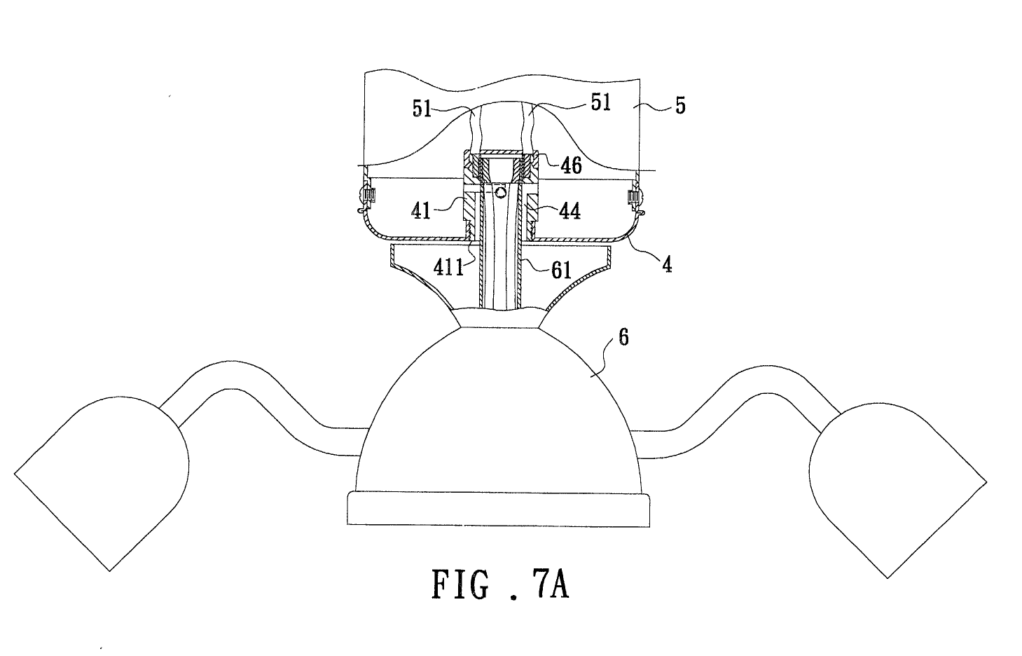

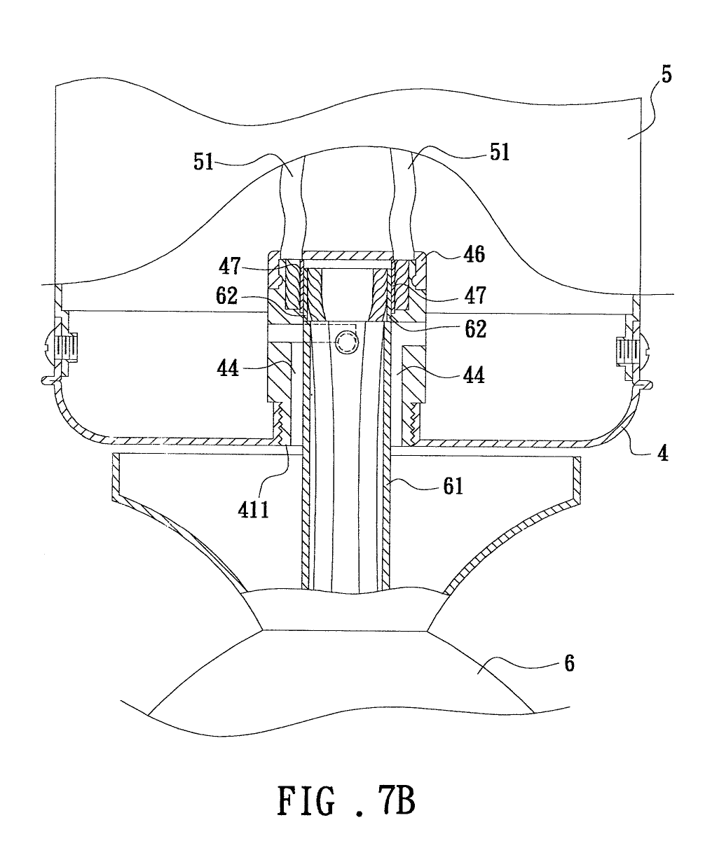

FIGS. 6 and 7 show still another embodiment of the present invention, in which the base tray 4 connected with the bottom of the ceiling fan 5 has an upward extending tube 41. Each of the tube 41 and the base tray 4 has a corresponding ratchet section 42a, 42b. When the tube 41 is rotarily disposed on the base tray 4, the ratchet sections 42a, 42b are engaged with each other to prevent the tube 41 from being rotated in reverse direction and untightened. The tube 41 has a bottom end 411 connected with the base tray 4 and a top end 412 opposite to the bottom end 411. An inner wall 43 of the tube 41 is formed with two radially opposite slide channels 44 downward passing through the tube 41. In addition, the inner wall 43 is formed with two radially opposite engaging notches 45. The top end of the tube 41 is provided with a cap 46 formed with two radially opposite holes vertically passing through the cap 46. Two wires 51 extending from the interior of the ceiling fan pass through the holes. The inner wall face of top end of the tube 41 is additionally formed with two recesses 431 each having an opening 432 facing inward. Two first conductive plates 47 are respectively disposed in the recesses 431. The first conductive plate 47 is resilient and in normal state is inward bent to protrude from the opening 432 of the recess 431. The tube 41 is further formed with two orifices 433 facing upward and respectively communicating with the first conductive plates 47. The wires pass through the orifices 433 to respectively contact with the first conductive plates 47.

The lamp seat 6 has an upward extending hollow post 61 for fitting into the tube 41. The post 61 has a top end 611 fitted into the tube 41. The top end 611 is provided with two radially opposite second conductive plates 62. The top end 611 is formed with two radially opposite cut face sections 612 corresponding to the first conductive plates 47 to form two radially opposite curved faces 613. The second conductive plates 62 are respectively disposed on the curved faces 613. A pin member 64 is radially passed through the post 61 near the top end 611 thereof under the second conductive plate 62. Two ends of the pin member 64 protrude out of the post 61 and are slidably accommodated in the slide channels 44 of the tube 41.

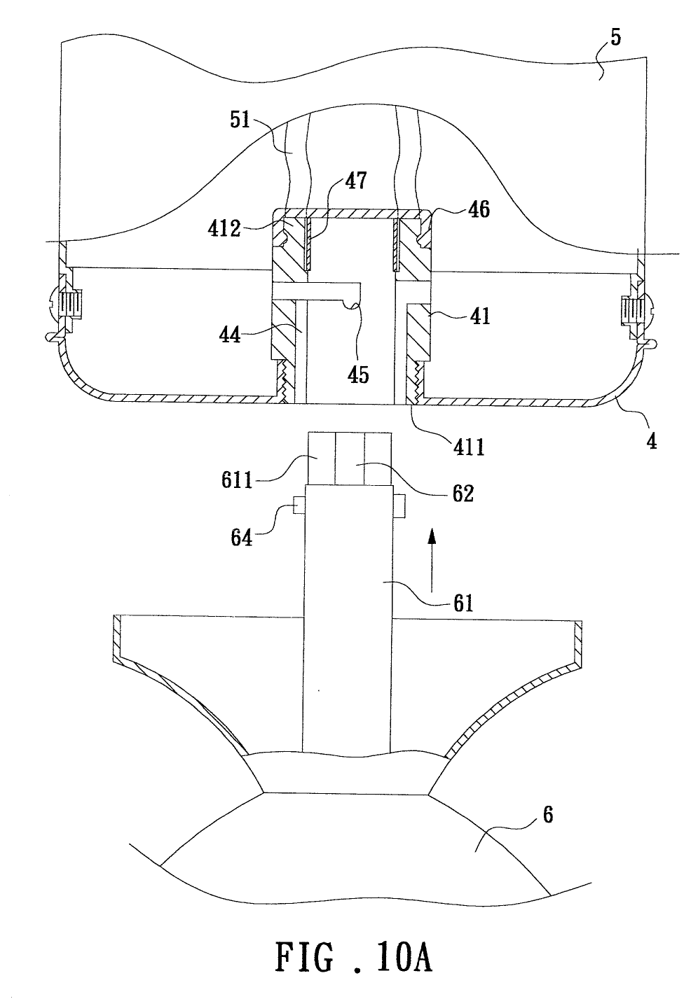

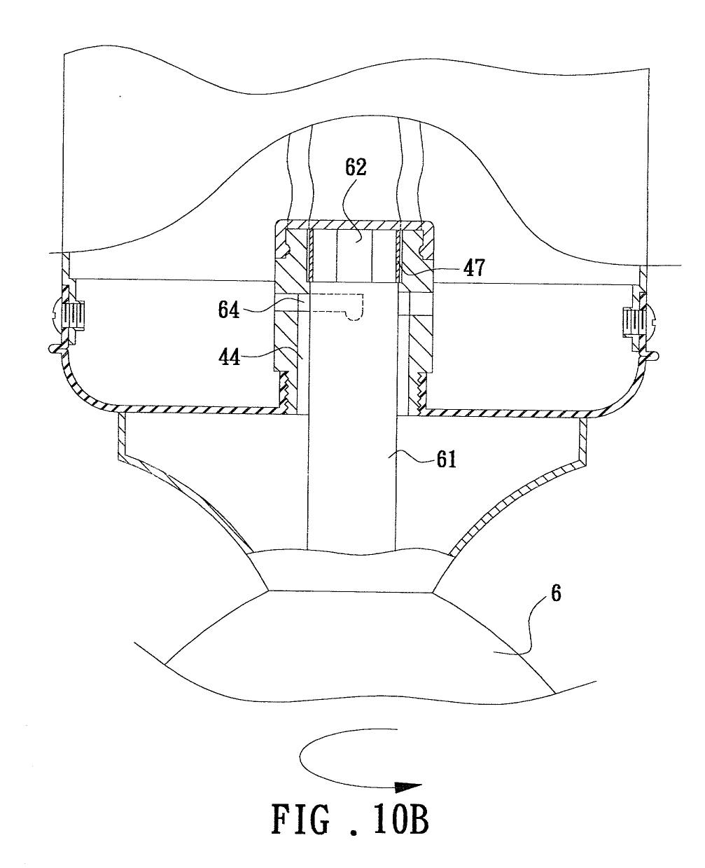

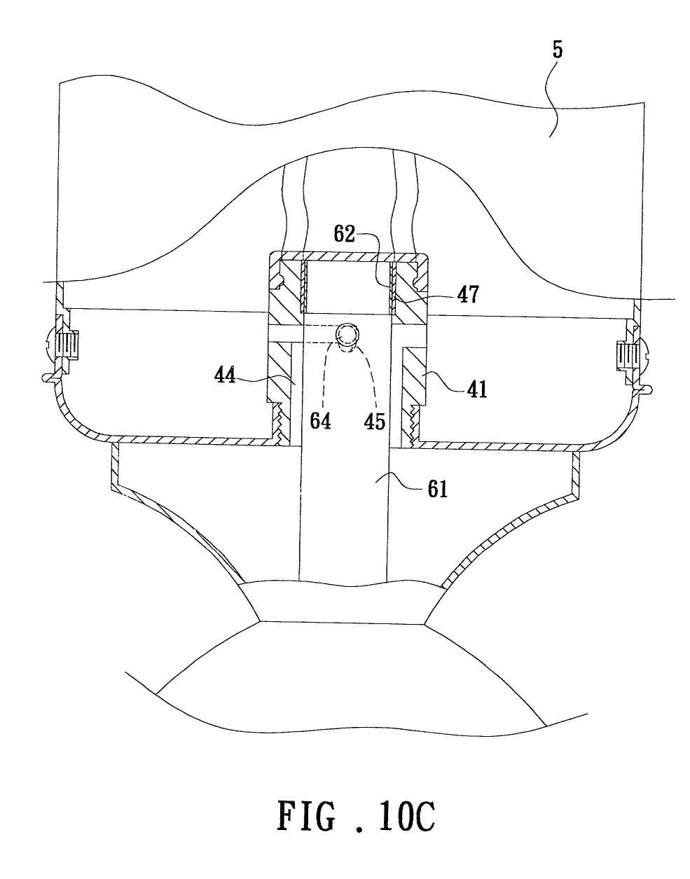

Referring to FIGS. 10A to 10C, when installing the lamp seat 6 on the ceiling fan 5, two ends of the pin member 64 are aimed at the slide channels 44 and the post 61 is upward fitted into the tube 41 and then rotated to make the second conductive plates 62 electrically contact with the first conductive plates 47.

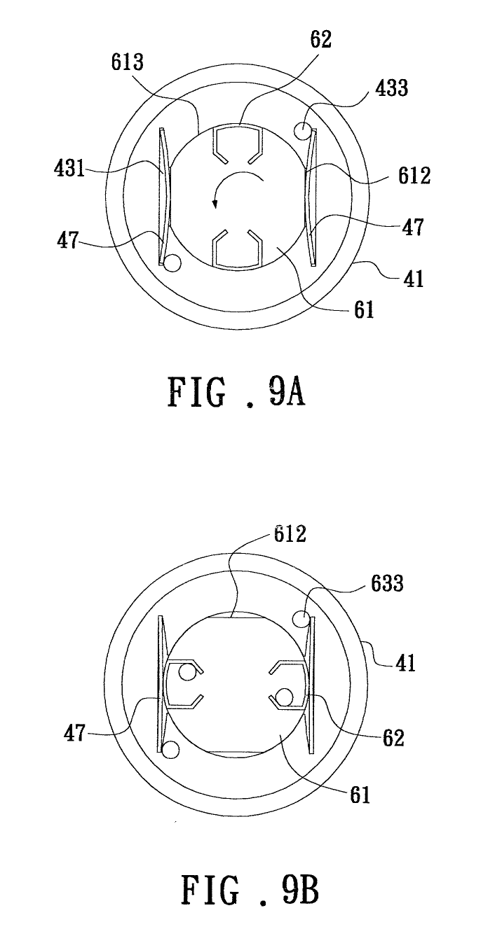

As shown in FIGS. 9A and 9B, the two cut face sections 612 of the hollow post 61 correspond to the inward bent first conductive plates 47, whereby the post 61 can be fitted into the tube 41 without being obstructed by the first conductive plates 47. When rotating the post 61, the second conductive plates 62 disposed on the curved faces 613 will press the resilient first conductive plates 47, whereby the second conductive plates 62 can effectively electrically contact with the first conductive plates 47.

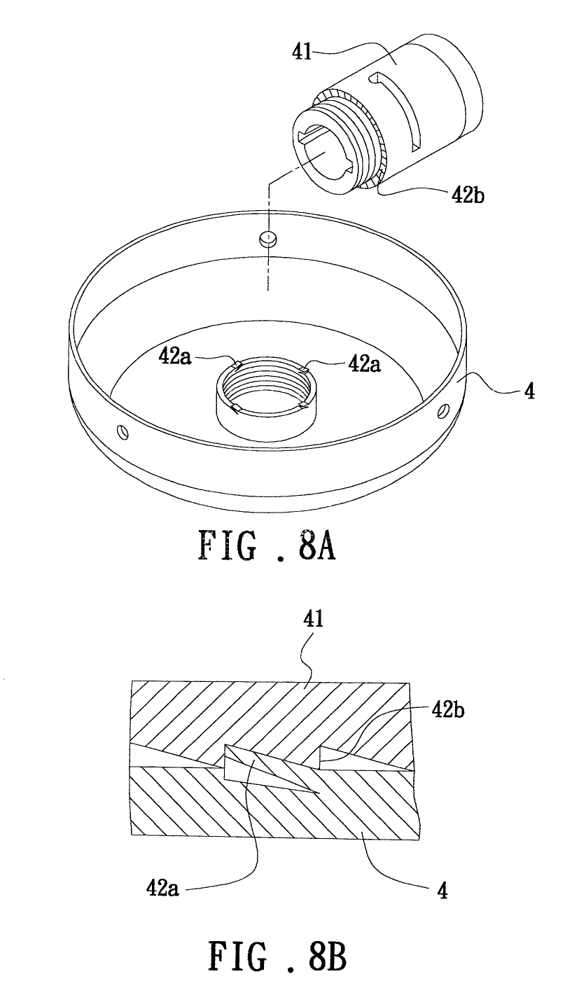

Moreover, as shown in FIGS. 8A and 8B, each of the tube 41 and the base tray 4 has a corresponding ratchet section 42a, 42b. Therefore, when the tube 41 is rotatably disposed on the base tray 4, the ratchet sections 42a, 42b are engaged with each other. When two ends of the pin member 64 of the post 61 are fitted into the slide channels 44 and further rotated, the ratchet sections 42a, 42b engaged with each other prevent the tube 41 from being untightened due to rotation of the post 61.

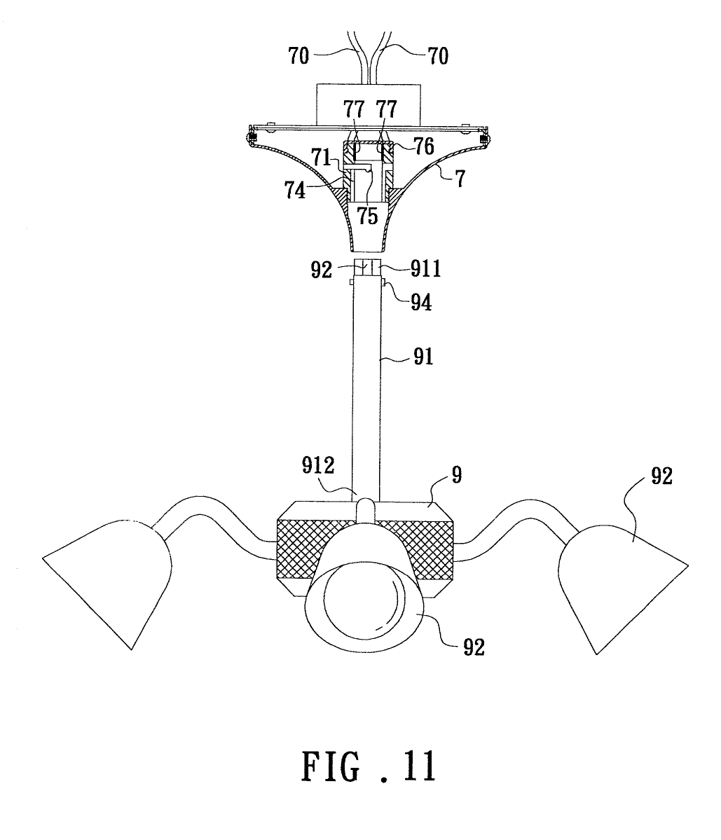

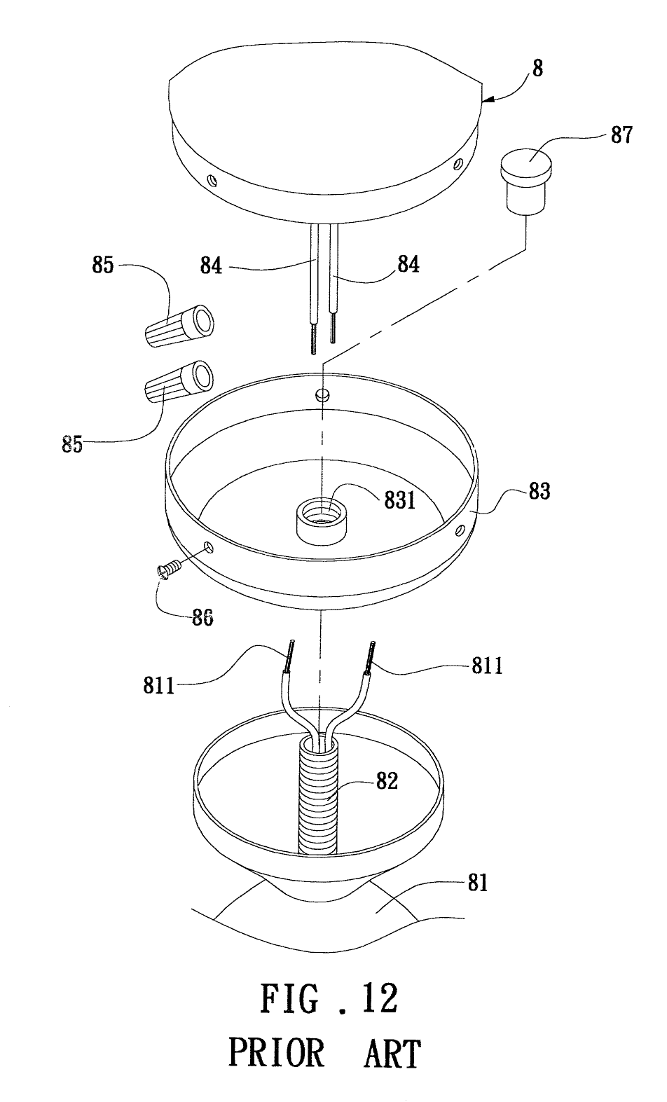

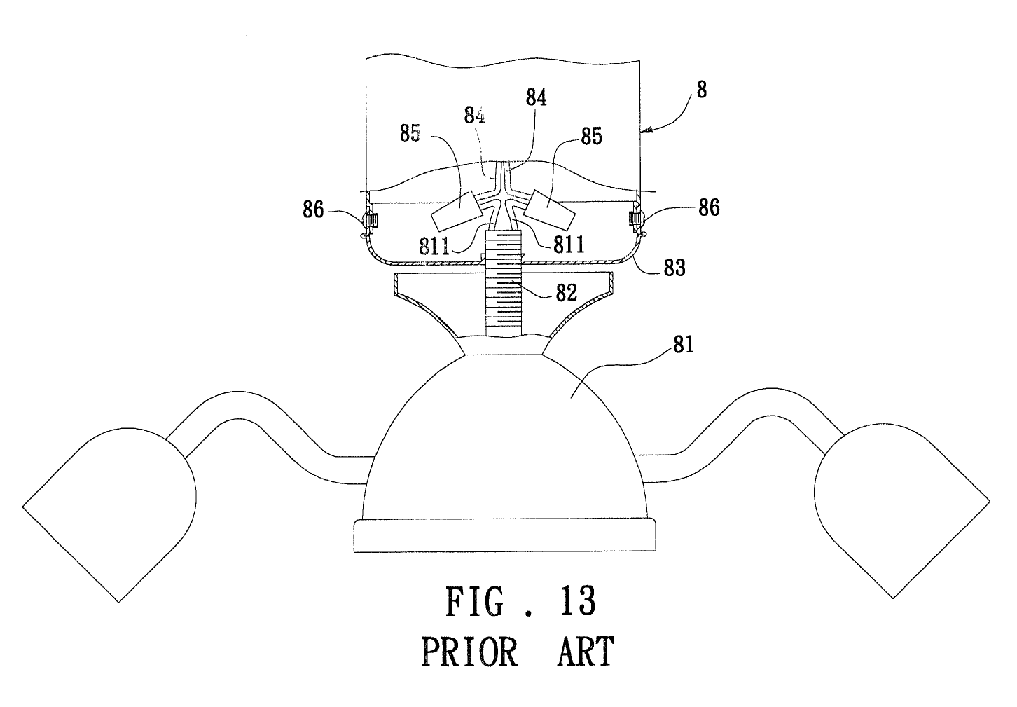

The application of the above assembly of the tube 41 and the post 61 is not limited to the ceiling lamp and ceiling fan. Also, the assembly is applicable to the suspending and assembling structure of various kinds of ceiling lamps. FIG. 11 shows still another embodiment of the present invention, in which the ceiling lamp includes a connecting section 7 fixed on a ceiling or at another predetermined position. The connecting section 7 has an upward extending tube 71. The inner wall of the tube 71 is formed with two slide channels 74 and two engaging notches 75. Two conductive plates 77 are disposed on the inner wall. A cap 76 is disposed at top end of the tube 71. The cap 76 is formed with holes passing through the cap 76. The wires 70 pass through the holes of the cap 76.

The lamp seat 9 of the ceiling lamp has an upward extending post 91 for fitting into the tube 71. The post 91 has a top end 911 fitted into the tube 71 and a bottom end 912 opposite to the top end 911. The bottom end 912 is provided with multiple lights 92. A pin member 94 and conductive plates 92 are disposed at the top end 911 corresponding to the conductive plates 77.

When installed, two ends of the pin member 94 are aimed at the slide channels 74 and the post 91 is upward fitted into the tube 71 and then rotated to make the conductive plates 92 electrically contact with the conductive plates 77. This achieves the same function as the above embodiment.

The above embodiments are only used to illustrate the present invention, not intended to limit the scope thereof. Many modifications of the above embodiments can be made without departing from the spirit of the present invention.

What is claimed is:

1. A suspending and assembling structure for ceiling lamp, comprising:
a connecting section fixed at a predetermined position, the connecting section having an upward extending tube, the tube having a bottom end connected with the connecting section and a top end opposite to the bottom end, the tube having an inner wall formed with two radially opposite slide channels axially extending and downward passing through the tube, the inner wall being further formed with two radially opposite engaging notches; and
a lamp seat having an upward extending hollow post for fitting into the tube, the post having a top end fitted into the tube, a pin member being radially passed through the post near the top end, two ends of the pin member protruding out of the post and being slidably accommodated in the slide channels of the tube, whereby the post is upward fitted into the tube and then rotated to aim the pin member at the engaging notches and engage and locate the pin therein.

2. A suspending and assembling structure for ceiling lamp, comprising:
a connecting section fixed at a predetermined position, the connecting section having an upward extending tube, the tube having a bottom end connected with the connecting section and a top end opposite to the bottom end, an inner wall of the tube being formed with two radially opposite slide channels axially passing through the tube, the inner wall being further formed with two radially opposite engaging notches, the top end of the tube being provided with a cap in which a wire-connecting disc is disposed, a resilient member being disposed between the wire-connecting disc and the cap, in normal state, the resilient member pushing the wire-connecting disc downward, the wire-connecting disc being connected with a circuit arranged in the ceiling fan and having two downward extending first contacts; and
a lamp seat having an upward extending hollow post for fitting into the tube, the post having a top end fitted into the tube and connected with a wire-connecting seat, the wire-connecting seat being connected with the wires inside the lamp seat and having two second contacts corresponding to the first contacts of the wire-connecting disc, a pin member being radially passed through the post near the top end thereof, two ends of the pin member protruding out of the post and being slidably accommodated in the slide channels of the tube, whereby the post is upward fitted into the tube and after the post is rotated to aim the pin member at the engaging notches, the resilient member resiliently pushes the pin member to engage and locate in the engaging notches, at this time, the second contacts of the wire-connecting seat electrically contacting with the first contacts of the wire-connecting disc.

3. A suspending and assembling structure for ceiling lamp, comprising:
a connecting section fixed at a predetermined position, the connecting section having an upward extending tube, the tube having an inner wall formed with two radially opposite slide channels axially extending and downward passing through the tube, the inner wall being further formed with two radially opposite engaging notches, the inner wall of the top end of the tube being further formed with two radially opposite first conductive plates, a cap being disposed at the top end of the tube; and
a lamp seat having an upward extending hollow post for fitting into the tube, the post having a top end fitted into the tube, a pin member being radially passed through the post near the top end, two ends of the pin member protruding out of the post and being slidably accommodated in the slide channels of the tube, two second conductive plates being disposed at the top end of the post corresponding to and radially opposite to the first conductive plates, the second conductive plates being higher than the pin member, whereby the post is upward fitted into the tube and then rotated to aim the pin member at the engaging notches to make the second conductive plates respectively electrically contact with the first conductive plates.

4. The suspending and assembling structure for ceiling lamp as claimed in claim 3, wherein the first conductive plates are slightly resilient and inward bent, the top end of the post being formed with two radially opposite cut face sections corresponding to the first conductive plates, whereby the post can be fitted into the tube and rotated to make the second conductive plates respectively press and electrically contact with the first conductive plates.

5. The suspending and assembling structure for ceiling lamp as claimed in claim 3, wherein each of the tube and the base tray has a corresponding ratchet section, whereby when the tube is rotarily disposed on the base tray, the ratchet sections are engaged with each other to prevent the tube from being rotated in reverse direction and untightened.

6. The suspending and assembling structure for ceiling lamp as claimed in claim 3, wherein the inner wall face of the tube is formed with two radially opposite recesses each having an opening facing inward, the first conductive plates being respectively disposed in the recesses, the first conductive plates being inward bent to protrude from the openings of the recesses.
